(19) United States
(12) Patent Application Publication
(10) Pub. No.: US 2014/0367030 A1
(43) Pub. Date: Dec. 18, 2014

(54) APPARATUSES AND METHODS TO PROCESS FLEXIBLE GLASS LAMINATES

(71) Applicant: Corning Incorporated, Corning, NY (US)

(72) Inventors: Roger Donald Beam, Albion, NY (US); Donald Orrin Bigelow, Honeoye Falls, NY (US); Daniel Patrick Gormel, Livonia, NY (US); Richard Jonathan Kohler, Hilton, NY (US)

(73) Assignee: Corning Incorporated, Corning, NY (US)

(21) Appl. No.: 14/286,466

(22) Filed: May 23, 2014

Related U.S. Application Data
(60) Provisional application No. 61/835,867, filed on Jun. 17, 2013.

(51) Int. Cl. B32B 37/00; B32B 43/00; B32B 38/10

(52) U.S. Cl. CPC B32B 37/0046; B32B 38/10; B32B 43/006
USPC 156/152; 156/767; 156/719; 156/379.6

(57) ABSTRACT

Apparatuses and methods for processing flexible glass are disclosed. The flexible glass is directed along a conveyance path through a glass laminate processing apparatus. The glass laminate processing apparatus includes a glass laminate pay-out spool paying out flexible glass and a first laminate material electrostatically pinned to each other in a glass laminate. The glass laminate processing apparatus also includes at least one electrostatic charging head positioned downstream of a pay-out spool, where the electrostatic charging head neutralizes an electrostatic charge on at least one of the flexible glass or the first laminate material that are electrostatically pinned to each another in the glass laminate. The glass laminate processing apparatus further includes a laminate material take-up spool positioned downstream of the electrostatic device collecting the first laminate material.

### PRIORITY

This application claims the benefit of priority under 35 U.S.C. §119 of U.S. Provisional Application Ser. No. 61/835,867 filed on Jun. 17, 2013, the content of which is relied upon and incorporated herein by reference in its entirety.

### BACKGROUND

1. Field

The present specification generally relates to apparatuses and methods for processing glass laminates, and, more particularly, to apparatuses and methods of applying and removing laminate material to flexible glass for processing the flexible glass.

2. Technical Background

Flexible glass may be formed by processes such as a fusion draw process or other similar downdraw processes. The fusion draw process typically yields glass with surfaces having superior flatness and smoothness as compared to glass produced by other manufacturing methods. Flexible glass formed by the fusion draw process can be used in a variety of devices including flat panel displays, touch sensors, photovoltaic devices and other electronic applications.

Flexible glass may be very thin and may exhibit a high degree of flexibility. Because of this flexibility, processing and transporting the flexible glass may be difficult. Further, the flexible glass may be more susceptible to surface damage, for example scratching or fractures, which may be caused by contaminants or surface irregularities. Such surface damage to the flexible glass may make processing the flexible glass difficult.

Accordingly, apparatuses and methods used in processing flexible glass may be desired to introduce a protective layer to the flexible glass.

### SUMMARY

Flexible glass may be collected after its initial production in a spooled format. Maintaining the flexible glass in the spooled format may facilitate improved handling and transportation of the flexible glass. The spooled flexible glass is unwound from the spool for processing, and may be wound onto a spool for transportation following processing. The flexible glass may be susceptible to damage caused by handling during the unwinding and winding operations and during manufacturing operations. Damage to the flexible glass may lead to rejection of the flexible glass by customers.

To reduce the likelihood of damage to the flexible glass, a laminate material is temporarily coupled to the flexible glass to form a glass laminate. The laminate material provides a barrier between the flexible glass and the components of the glass processing apparatus in the winding operation and the unwinding operation. The present disclosure is directed to apparatuses and methods for electrostatically pinning a laminate material to the flexible glass to form the glass laminate. The laminate material may provide stability to the glass laminate when the glass laminate is wound off of or onto a spool and may reduce contact between the flexible glass and components of a glass laminate processing apparatus during the winding operations and the unwinding operations. The apparatuses described herein may be used in glass processing applications to separate the laminate material from the flexible glass that is wound off of a payout spool as a glass laminate, thereby allowing the flexible glass to be processed independently of the laminate material. Apparatuses described herein also couple a laminate material to the flexible glass by electrostatically pinning the laminate and the flexible glass, thereby forming a glass laminate. The glass laminate may be wound onto a take-up spool for transportation following processing of the flexible glass.

According to one embodiment, a glass laminate processing apparatus for processing flexible glass includes a plurality of processing stations arranged to direct the flexible glass along a conveyance path in a downstream direction. The glass laminate processing apparatus includes a glass laminate pay-out spool paying out flexible glass and a first laminate material electrostatically pinned to each other in a glass laminate. The glass laminate processing apparatus also includes an electrostatic device positioned downstream of the pay-out spool, where the electrostatic device neutralizes an electrostatic charge on at least one of the flexible glass or the first laminate material that are electrostatically pinned to each another in the glass laminate. The glass laminate processing apparatus further includes a laminate material take-up spool positioned downstream of the electrostatic device collecting the first laminate material.

In another embodiment, a method of processing glass laminate includes directing a glass laminate through a glass laminate processing apparatus, where the glass laminate includes a flexible glass having a first polarity and a first laminate material having a second polarity opposite the first polarity and the flexible glass and the first laminate material are electrostatically pinned to each other by the first and second polarities. The method also includes neutralizing at least one of the first polarity or the second polarity with an electrostatic device positioned proximate to the glass laminate to unpin the flexible glass and the first laminate material, separating the flexible glass from the first laminate material, collecting the first laminate material, and processing the flexible glass in a manufacturing operation station positioned along a conveyance path of the flexible glass through the glass laminate processing apparatus.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic side perspective view of a glass laminate processing apparatus having a plurality of processing stations according to one or more embodiments shown or described herein;

FIG. 2 is a schematic front view of a separation apparatus of the glass laminate processing apparatus of FIG. 1 according to one or more embodiments shown or described herein;

FIG. 3 is a schematic front view of a glass laminate forming apparatus of the glass laminate processing apparatus of FIG. 1 according to one or more embodiments shown or described herein; and

FIG. 4 is a cross-sectional view of a glass laminate take-up spool depicted along line A-A of FIG. 3 according to one or more embodiments shown or described herein.

### DETAILED DESCRIPTION

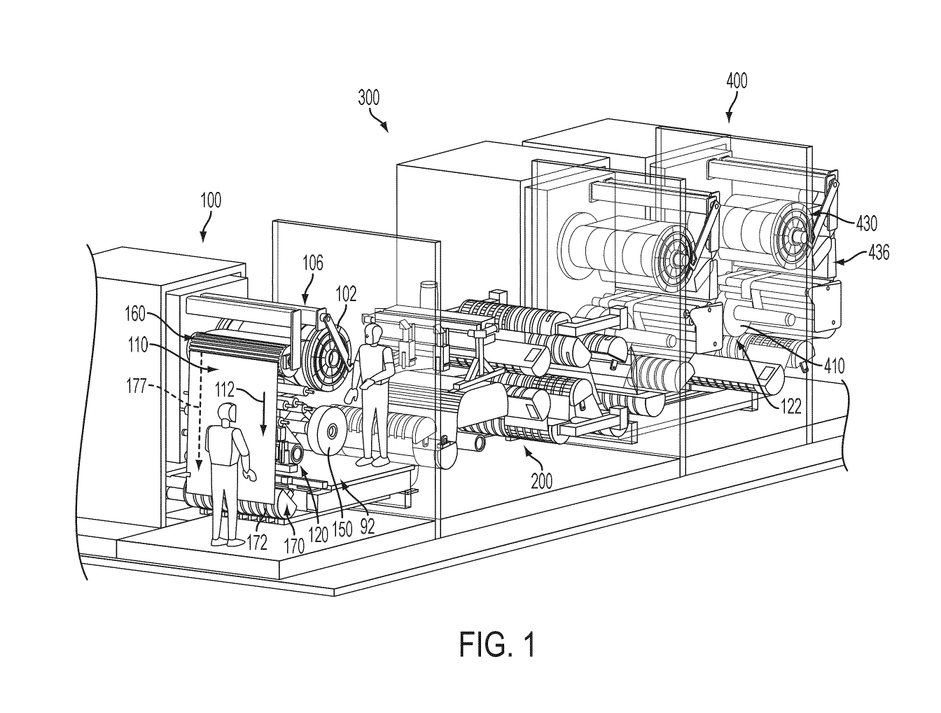

Reference will now be made in detail to various embodiments of apparatuses and methods for separating a laminate material from flexible glass, and coupling a laminate material to processed flexible glass, examples of which are depicted in the accompanying drawings. Whenever possible, the same reference numerals will be used throughout the drawings to refer to the same or like parts. FIG. 1 generally depicts one embodiment of a glass laminate processing apparatus used to process flexible glass in a spool-to-spool process. When the glass laminate is unspooled from the glass laminate spool, the glass laminate has an initial electrostatic charge, with the flexible glass having a first electrostatic polarity and the first laminate material having a second electrostatic polarity that is opposite the first electrostatic polarity. The opposing electrostatic charges contained by the flexible glass and the first laminate material create an electrostatic bond between the two components. The electrostatic bond maintains the positioning between the flexible glass and the first laminate material, and may be referred to as being electrostatically pinned. The electrostatic bond may provide a more stable glass laminate during spooling and un-spooling. However, the electrostatic bond may create difficulty in separating the flexible glass from the first laminate material when the flexible glass is processed independently of the first laminate material.

The glass laminate processing apparatus depicted in FIG. 1 includes a plurality of processing stations including a separation apparatus that separates a glass laminate into flexible glass and a laminate material, allowing the flexible glass to be processed independently of the laminate material. The glass laminate processing apparatus also includes at least one processing station to process the flexible glass. The glass laminate processing apparatus further includes a processing station that groups the flexible glass to a laminate material using opposing electrostatic charges, referred to as electrostatically pinning. The electrostatic pinning of the flexible glass and the laminate material form a processed glass laminate. The flexible glass may be transported to and from the processing apparatus as the glass laminate wound about a spool. The laminate material provides protection to the flexible glass during transportation and during wind and unwind operations of the glass laminate processing apparatus. The laminate material may also reduce telescoping of the flexible glass on the spool such that subsequent layers of flexible glass on the spool are aligned with one another. Likelihood of damage to the flexible glass during the unwinding operation may therefore be reduced by the addition of the laminate material.

Referring to FIG. 1, one embodiment of the glass laminate processing apparatus 300 is depicted. In the depicted embodiment, the glass laminate processing apparatus 300 includes a separation apparatus 100, a glass laminate forming apparatus 400, and a plurality of manufacturing operation stations 200. The glass laminate 106, or alternatively the flexible glass 110, travels through the processing stations of the glass laminate processing apparatus 300 along a conveyance path 177.

The flexible glass 110 is introduced to the glass laminate processing apparatus 300 at a glass laminate pay-out spool 102. The flexible glass 110 is held on the glass laminate pay-out spool 102 as a glass laminate 106 of the flexible glass 110 and a first laminate material 120 that are coupled to one another through an electrostatic attraction. The glass laminate processing apparatus 300 includes a tensioning roller 160 positioned in a downstream direction 112 from the glass laminate pay-out spool 102. The glass laminate 106 is drawn over the tensioning roller 160, with the first laminate material 120 contacting the tensioning roller 160 such that the flexible glass 110 does not contact the tensioning roller 160. The tensioning roller 160 maintains tension in the flexible glass 110 as the flexible glass 110 is paid-out from the glass laminate pay-out spool 102. The tensioning roller 160 may also assist in separating the glass laminate 106 into the flexible glass 110 and a first laminate material 120. Separated from the first laminate material 120, the flexible glass 110 continues along the conveyance path 177 and passes through the manufacturing operation stations 200 in which manufacturing operations are performed on the flexible glass 110.

After being separated from the first laminate material 120, the flexible glass 110 may continue through at least one manufacturing operation station 200. The flexible glass 110 may undergo manufacturing operations, for example and without limitation, to trim, etch, print, or polish, or grind the flexible glass 110 in the at least one manufacturing operation station 200.

Following processing in the manufacturing operation stations 200, the flexible glass 110 may be joined with a second laminate material 122 to form a processed glass laminate 436. The second laminate material 122 protects the flexible glass 110 and reduces the likelihood of damage to the flexible glass 110. After the flexible glass 110 is processed by the manufacturing operation stations 200, the flexible glass 110 is directed to the glass laminate forming apparatus 400, where the flexible glass 110 is electrostatically pinned to a second laminate material 122 to form the processed glass laminate 436. The processed glass laminate 436 is wound onto a processed glass take-up spool 430.

Separating the flexible glass 110 from the first laminate material 120, processing the flexible glass 110 independently of a laminate material, and coupling the flexible glass 110 to the second laminate material 122 allows the flexible glass 110 to be stored and/or transported as a glass laminate 106 or a processed glass laminate 436 where the first laminate material 120 or the second laminate material 122 acts as a protective layer for the flexible glass 110. The first laminate material 120 and the second laminate material 122 may reduce exposure of the flexible glass 110 and reduce the likelihood of damage to the flexible glass 110.

The flexible glass 110 may have a thickness of about 0.3 mm or less, including, for example and without limitation, thicknesses from about 0.01 to about 0.25 mm, such as from about 0.05 to about 0.20 mm. In one embodiment, the thickness of the flexible glass 110 may be from about 0.1 to about 0.18 mm.

The first laminate material 120 may be formed from materials such as polymers, polyethylene foam, corrugated paper material, or polyvinyl material with an embossed or textured surface. The first laminate material 120 may also be thickness compliant such that the first laminate material 120 is compressible. In other embodiments, the first laminate material 120 may be rigid in the thickness direction such that the first laminate material 120 is incompressible.

The flexible glass 110 and the first laminate material 120 may be coupled to one another through an electrostatic pinning relationship between the flexible glass 110 and the first laminate material 120. The flexible glass 110 and the first laminate material 120 may have opposite polarity ions along adjacent surfaces. When the flexible glass 110 and the first laminate material 120 are positioned proximate to one another, the opposite polarity of the ions are attracted to one another and maintain the relative positioning of the flexible glass 110 and the first laminate material 120. Thus, the opposite electrostatic charges of the flexible glass 110 and the first laminate material 120 maintain the integrity of the glass laminate 106 as it is transported to the glass laminate processing apparatus 300.

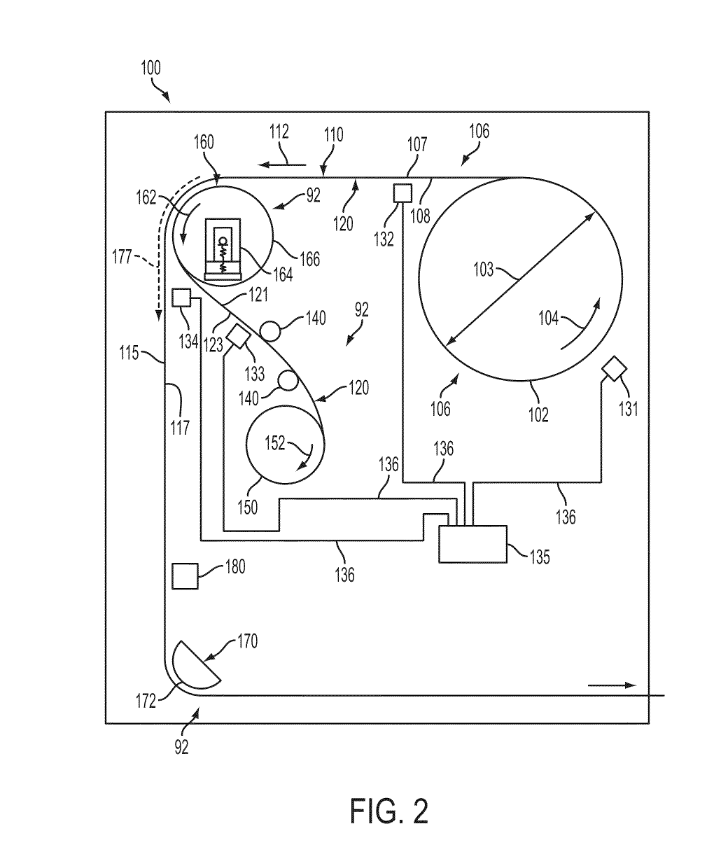

Referring to FIG. 2, a portion of one embodiment of the separation apparatus 100 incorporated into the glass laminate processing apparatus is depicted. The glass laminate 106 is initially held on the glass laminate pay-out spool 102, which is selectively positioned within the separation apparatus 100. The glass laminate pay-out spool 102 rotates in a payout direction 104, allowing the glass laminate 106 to be unspooled from the glass laminate spool 102. The glass laminate 106 is fed in the downstream direction 112 through the plurality of stations of the separation apparatus 100. The separation apparatus 100 includes a plurality of turning members 92. The turning members 92 may include nip rollers 140, tensioning roller 160, and fluid injection bars 170, each of which may guide the flexible glass 110 and/or the first laminate material 120 as they move within the separation apparatus 100 following the conveyance path 177, as discussed further below.

The separation apparatus 100 also includes an electrostatic device 135 that may include components such as a communicator module, a power supply module, a power strip, neutralizing bars, pinning bars, or the like. The electrostatic device 135 may be electrically coupled to a plurality of electrostatic charging heads 131, 132, 133, 134 through electrical leads 136. In some embodiments (not shown), the electrostatic device 135 may be integrated into the electrostatic charging heads 131, 132, 133, 134. In general, each of the electrostatic charging heads 131, 132, 133, 134 introduces ions to a position proximate to the surfaces of the glass laminate 106 or the components of the glass laminate 106, and imparts a field of electrostatic charge to the glass laminate 106 or the components of the glass laminate 106. The charge imparted by the electrostatic charging heads 131, 132, 133, 134 has a charge intensity that is pre-determined based, in part, on operational parameters of the separation apparatus 100. In the embodiment shown in FIG. 2, there are four surfaces of the glass laminate 106 that are neutralized while passing through separation apparatus 100. Each of the four surfaces is neutralized by one of the four electrostatic charging heads 131, 132, 133, 134. The first electrostatic charging head 131 neutralizes a first surface 115 of the flexible glass 110, which corresponds to the outer surface 107 of the glass laminate 106 while the glass laminate 106 is positioned on the glass laminate spool 102. The second electrostatic charging head 132 neutralizes a first surface 121 of the first laminate material 120, which corresponds to the inner surface 108 of the glass laminate 106 while the glass laminate 106 is positioned on the glass laminate spool 102. The second electrostatic charging head 132 is positioned at a location in the downstream direction 112 along the conveyance path 177 at which the glass laminate 106 has been unwound from the glass laminate spool 102. The third electrostatic charging head 133 neutralizes a second surface 123 of the first laminate material 120 at a position after the flexible glass 110 is separated from the first laminate material 120. The fourth electrostatic charging head 134 neutralizes a second surface 117 of the flexible glass 110 at a position after the flexible glass 110 is separated from the first laminate material 120. While specific mention has been made herein to the quantity of electrostatic charging heads incorporated into the separation apparatus 100, it should be understood that the quantity of electrostatic charging heads that are incorporated into the separation apparatus 100 may be varied to neutralize or apply charge to components of the first laminate material 120 without departing from the scope of the present disclosure.

As the flexible glass 110 and the first laminate material 120 are translated past each of the electrostatic charging heads 131, 132, 133, 134, the ions introduced by the electrostatic charging heads 131, 132, 133, 134 are directed towards surfaces of the flexible glass 110 and the first laminate material 120. Ions having opposite polarity to the initial electrostatic charge of the flexible glass 110 and the first laminate material 120 are broadcast towards one another, thereby neutralizing the electrostatic charge on the flexible glass 110 and the first laminate material 120. In some embodiments, the ions introduced by the electrostatic charging heads 131, 132, 133, 134 disrupt molecular bonds between the flexible glass 110 and the first laminate material 120. With the electrostatic charge on the flexible glass 110 and the first laminate material 120 neutralized, ease of separation of the first laminate material 120 from the flexible glass 110 may be improved.

In some embodiments of the separation apparatus 100, at least one of the electrostatic charging heads 131, 132, 133, 134 may include a fluid knife that ejects a fluid having positively and negatively charged free ions towards the glass laminate 106. In another embodiment, at least one of the electrostatic charging heads 131, 132, 133, 134 may include an ionizing bar or an ionizing tube that casts ions towards the surfaces of the glass laminate 106. In another embodiment, at least one of the electrostatic charging heads 131, 132, 133, 134 may include an electromagnetic emitter, for example, an x-ray generator, that ionizes molecules positioned proximate to the glass laminate 106. One example of an electrostatic device and electrostatic charging heads is Communicator Module No. 8300, Power Supply Module No. 8100, Power Strip No. 8026, and Neutralizing Bars No. 8011KDT, which are commercially available from Simco-Ion of Alameda, Calif.

As depicted in FIG. 2, the tensioning roller 160 is positioned to contact the glass laminate 106 at a position along the conveyance path 177 after the glass laminate has passed the first and second electrostatic charging heads 131, 132. The tensioning roller 160 may include a contact surface 166 that contacts the first laminate material 120. The contact surface 166 may be compliant and flexible to minimize damage to the first laminate material 120 as the glass laminate 106 is translated about the tensioning roller 160. The tensioning roller 160 may include a tensioning mechanism 164, for example, a spring-loaded tensioner, that modifies the position of the tensioning roller 160, and therefore the contact surface 166, thereby increasing or decreasing the distance the flexible glass 110 travels when translating along the conveyance path 177. The tensioning roller 160 may therefore modify the downstream tension of the flexible glass 110. Once the tensioning mechanism 164 has been adjusted to provide the desired tension in the flexible glass 110, the tensioning roller 160 may reposition autonomously. As such, the tensioning mechanism 164 autonomously adjust the position of the tensioning roller 160, along with the glass laminate 106 traversing around the tensioning roller 160, to accommodate variations in the flexible glass 110.

The tensioning mechanism 164 of the tensioning roller 160 may also include an electric motor (not shown) that controls the rate of rotation of the tensioning roller 160 and the glass laminate 106 contacting the tensioning roller 160. In these embodiments, the tensioning roller 160 controls the velocity at which the glass laminate 106 is drawn from the glass laminate spool 102 by controlling the velocity at which the glass laminate 106 continues through the glass laminate processing apparatus 300. The tensioning roller 160 may also control the velocity of the flexible glass 110 at the other processing stations within the glass laminate processing apparatus.

The tensioning roller 160 may contact the flexible glass 110 directly or may include air shielding capabilities such that the tensioning roller 160 avoids mechanical contact with the glass laminate 106. The tensioning roller 160 rotates in the tensioning direction 162, guiding the glass laminate 106 along the conveyance path 177.

The effective diameter 103 of the glass laminate pay-out spool 102 may vary over time, and therefore the rate of rotation of the glass laminate spool 102 may change for a fixed linear velocity of the glass laminate 106. However, the diameter of the tensioning roller 160 is generally fixed. Therefore, the tensioning roller 160 may be rotated at a constant rate of rotation and thereby provide a constant linear feed rate of the glass laminate 106 through the glass laminate processing apparatus.

In some embodiments, the glass laminate pay-out spool 102 may also contribute to the tension of the flexible glass 110 as the flexible glass 110 passes through the glass laminate processing apparatus. In these embodiments, the rate of rotation of the glass laminate pay-out spool 102 may be controlled such that the tension in the flexible glass 110 is uniform as the flexible glass 110 is unwound from the glass laminate pay-out spool 102. In these embodiments, the torque and/or rate of rotation of the pay-out spool 102 may be controlled to account for variations in the effective diameter 103 of the pay-out spool 102.

The separation apparatus 100 also includes at least one nip roller 140 positioned downstream from the tensioning roller 160 that assists in separating the first laminate material 120 from flexible glass 110. The nip rollers 140 may extend across at least a portion of the width of the glass laminate 106 or first laminate material 120. After the electrostatic charges previously applied to the flexible glass 110 and the first laminate material 120 have been dissipated in a substantial portion by the electrostatic device 135, the first laminate material 120 is separated from the flexible glass 110. The nip rollers 140 are positioned proximate to the first laminate material 120 to contact either the first surface 121 or the second surface 123 of the first laminate material 120. In the embodiment depicted in FIG. 2, a plurality of nip rollers 140 are positioned proximate to both the first surface 121 and the second surface 123 of the first laminate material 120. The plurality of nip rollers 140 are positioned in the downstream direction 112 relative to the third electrostatic charging head 133. As the flexible glass 110 and the first laminate material 120 are translated away from the tensioning roller 160, the nip roller 140 contacts the first laminate material 120 to guide the first laminate material 120 away from the flexible glass 110, which continues along the glass laminate processing apparatus along the conveyance path 177. Prior to being wound onto the laminate material take-up spool 150, the first laminate material 120 passes proximate to the third electrostatic charging head 133, which is positioned near the second surface 123 of the first laminate material 120. Because the second surface 123 of the first laminate material 120 was previously matched with the second surface 117 of the flexible glass 110, the second surface 123 was previously unexposed. The third electrostatic charging head 133 neutralizes the second surface 123 of the first laminate material 120. The first laminate material 120 may be guided by additional nip rollers and wound onto the laminate material take-up spool 150.

As the first laminate material 120 is wound onto the laminate material take-up spool 150, the laminate material take-up spool 150 is rotated in take-up direction 152 such that laminate material take-up spool 150 continuously collects the first laminate material 120 as the first laminate material 120 is separated from the glass laminate 106. Winding the first laminate material 120 onto the laminate material take-up spool 150 allows the first laminate material 120 to be recovered and reused in subsequent operations. In some embodiments, the first laminate material 120 may be collected as refuse, recycled, or otherwise removed from the glass laminate processing apparatus. The nip rollers 140 may include an electrical grounding connection that provides an electrical ground to the nip rollers 140. In these embodiments, the nip rollers 140 may dissipate any electrical charge that builds on their surfaces due to contact or proximity to the flexible glass 110 or the first laminate material 120. In other embodiments, the nip rollers 140 may be constructed from a material that resists a build-up of static electricity, such that the nip rollers 140 do not become electrically charged due to contact or proximity to the flexible glass 110 or the first laminate material 120. In such embodiments, the nip rollers 140 may be constructed from an inherently static dissipative material. In other embodiments, the nip rollers 140 may be positioned such that the nip rollers 140 are beyond the field of charge imparted by the electrostatic charging head 133. As such, the nip rollers 140 may remain substantially electrostatically neutral such that any residual charge of the flexible glass 110 or the first laminate material 120 do not affect operation of the separation apparatus 100.

The flexible glass 110 continues along the glass laminate processing apparatus 300 independently of the first laminate material 120. After being separated from the first laminate material 120, the flexible glass passes proximate to the fourth electrostatic charging head 134. The fourth electrostatic charging head 134 neutralizes the second surface 117 of the flexible glass 110, which was previously unexposed as the flexible glass 110 was laminated to the first laminate material 120. As discussed hereinabove, the flexible glass 110 continues along a plurality of turning members 92 as the flexible glass 110 is fed through the separation apparatus 100. Examples of such turning members 92 include the tensioning roller 160 and the fluid injection bars 170.

The fluid injection bars 170 are also positioned proximate to the flexible glass 110 and are used to assist with turning the flexible glass 110 along the conveyance path 177. The fluid injection bars 170 include an ejection surface 172 that is positioned proximate to the flexible glass 110. Fluid is ejected through perforations in the ejection surface 172. The ejected fluid is directed through the ejection surface 172 and onto the flexible glass 110 as the flexible glass 110 is turned to follow the conveyance path 177. The fluid ejected through the ejection surface 172 forms a fluid cushion between the flexible glass 110 and the ejection surface 172. This fluid cushion maintains spacing between the ejection surface 172 and the flexible glass 110, such that mechanical contact between the ejection surface 172 of the fluid injection bar 170 and the flexible glass 110 is minimized. Reducing mechanical contact with the flexible glass 110 may reduce scratches, cracks, fractures, or contamination of the flexible glass 110.

The fluid injection bars 170 may be placed in fluid communication with a fluid reservoir (not shown), which supplies the fluid injection bars 170 with a supply of fluid at an elevated pressure above ambient pressure. Examples of such fluids include, without limitation, gaseous air, nitrogen, helium, oxygen, argon, and the like. The pressure of the fluid introduced to the fluid injection bars 170 may managed to accommodate variations in the tension of the flexible glass 110 and/or control the tension in the flexible glass 110 by adjusting the amount and velocity of fluid ejected through the ejection surface 172 of the fluid injection bars 170. The fluid ejected through the ejection surface 172 forms a fluid cushion between the ejection surface 172 and the flexible glass 110 that maintains spacing between the ejection surface 172 and the flexible glass 110. The fluid cushion thereby eliminates contact between the fluid injection bar 170 and the flexible glass 110.

As discussed hereinabove, the plurality of electrostatic charging heads 131, 132, 133, 134 neutralize all or some of the electrostatic charge maintained on first and second surfaces of the flexible glass 110 and the first laminate material 120. Neutralizing the electrostatic charges on the flexible glass 110 and the first laminate material 120 of the glass laminate 106 may improve the separability of the flexible glass 110 from the first laminate material 120. In some embodiments, the electrostatic charging heads 131, 132, 133, 134 may add electrostatic charge to the first laminate material 120 and flexible glass 110 rather than neutralize existing charges in the first laminate material 120 and flexible glass 110. The amount of charge imparted can depend upon, among other variables, the thickness of the flexible glass 110 and parameters of the first laminate material 120, such as its thickness, the type of material of which it is made, and the permeability of the material to ions.

The flexible glass 110 may also pass proximate to a glass tension monitoring device 180, for example and without limitation, a linescan camera, speed detection device, or other tension monitoring device. The glass tension monitoring device 180 is in electronic communication with a controller, and may relay data related to tension to the controller to ensure uniform velocity of the flexible glass 110 throughout the glass laminate processing apparatus 300. The glass tension monitoring device 180 may ensure that the glass laminate processing apparatus 300 keeps the flexible glass 110 at a tension in a range from about 0.05 pounds per linear inch of width of the flexible glass 110 to about 0.75 pounds per linear inch of width of the flexible glass 110. Tension of the flexible glass 110 may also be adjusted throughout the glass laminate processing apparatus by adjusting the volume and/or pressure of fluid supplied to the fluid injection bar 170. The flexible glass 110 may pass proximate to one or more additional fluid injection bars (not shown) before exiting the separation apparatus 100.

Referring again to FIG. 1, after departing the separation apparatus 100, the flexible glass 110 may continue through additional processing stations of the manufacturing operation stations 200 in a conveyance process. The conveyance process may include conveying the flexible glass 110 through the processing stations in which manufacturing operations are performed on the flexible glass 110. Examples of such processing stations through which the flexible glass 110 may be conveyed include, for example and without limitation, grinding stations, polishing stations, cleaning stations, the thin film device formation stations, cutting stations, splicing stations, roll-to-roll handing stations, etching stations, or lamination stations in which the flexible glass 110 is laminated to other films or structures. Following processing of the flexible glass 110 in one or more of the processing stations, the flexible glass 110 may be removed from the glass processing apparatus 300.

In some embodiments, a second laminate material may be coupled to the flexible glass 110 after processing as to protect the flexible glass 110 and any components formed on the flexible glass 110. The glass laminate processing apparatus 300 used in these embodiments may include a glass laminate forming apparatus 400 that couples the second laminate material to the flexible glass 110 after the flexible glass 110 has been processed through the at least one manufacturing operation stations 200.

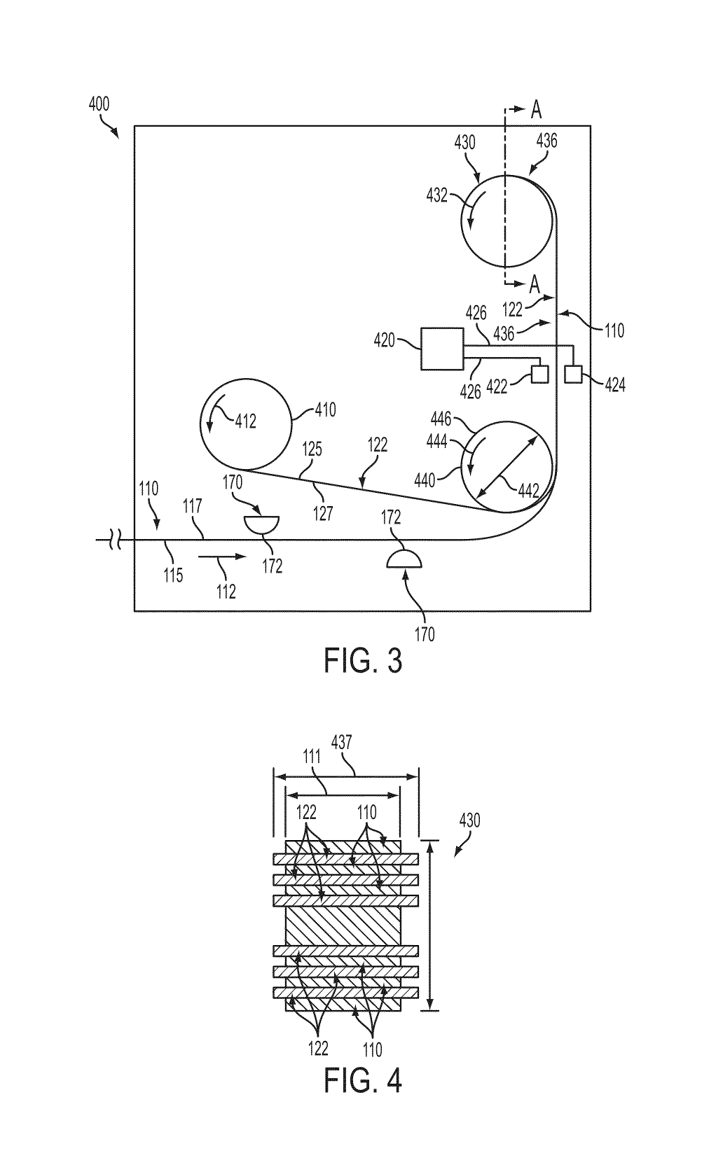

Referring now to FIG. 3, one embodiment of the glass laminate forming apparatus 400 is depicted. The glass laminate forming apparatus 400 includes an electrostatic charge generator 420 that is coupled to a first electrostatic charging head 422 and a second electrostatic charging head 424 via electrical leads 426. In some embodiments (not shown), the electrostatic charge generator 420 may be integrated into the electrostatic charging heads 422, 424. The glass laminate forming apparatus 400 also includes a second laminate material spool 410 from which a second laminate material 122 is dispensed. The second laminate material spool 410 rotates in laminate pay-out direction 412, allowing the second laminate material 122 to be unwound from the second laminate material spool 410.

The flexible glass 110 enters the glass laminate forming apparatus 400 after exiting from the glass processing stations (as shown in FIG. 1) in the downstream direction 112 towards the processed glass take-up spool 430. One or more fluid injection bars 170 guide the flexible glass 110 into and/or through the glass laminate forming apparatus 400. In one embodiment, the flexible glass 110 and the second laminate material 122 are brought into close proximity or into contact with one other as the flexible glass 110 and the second laminate material 122 approach a turning roller 440. The turning roller 440 rotates in direction 444 and has an outer surface 446 that contacts a first surface 125 of the second laminate material 122. As the second laminate material 122 approaches the turning roller 440, a second surface 127 of the second laminate material 122 comes in close proximity to the second surface 117 of the flexible glass 110. As the flexible glass 110 and second laminate material 122 pass around the turning roller 440, the second surface 127 of the second laminate material 122 contacts the second surface 117 of the flexible glass. The outer surface 446 of the turning roller 440 may be compliant and flexible to minimize damage to the second laminate material 122. The turning roller has a diameter 442 that may be varied to adjust a rotational velocity of the turning roller 440.

FIG. 3 schematically depicts the first and second electrostatic charging heads 422,424 that impart electrostatic charges on a first surface 115 of the flexible glass 110 and the second laminate material 122, respectively. In the embodiment depicted in FIG. 3, the flexible glass 110 and the second laminate material 122 travel along downstream direction 112 toward the first and second electrostatic charging heads 422,424. The second laminate material 122 may be charge neutral at positions upstream of the first and second electrostatic charging heads 422, 424. The flexible glass 110 may also be charge neutral at positions upstream of the first and second electrostatic charging heads 422, 424. In the depicted embodiment, the first electrostatic charging head 422 imparts a charge on the second laminate material 122 and the second electrostatic charging head 424 imparts an opposite charge on the flexible glass 110. In another embodiment, the flexible glass 110 and second laminate material 122 are brought into contact with one another at a position downstream of the first and second electrostatic charging heads 422, 424, and are first pinned together by an electrostatic bond between the opposing electrostatic charges imparted by the first and second electrostatic charging heads 422,424. The flexible glass 110 and second laminate material 122 form the processed glass laminate 436. The processed glass laminate 436 is subsequently wound onto the processed glass take-up spool 430, which rotates in take-up direction 432. The processed glass take-up spool 430 collects the processed glass laminate 436 by winding the processed glass laminate 436 into layers.

The first and second electrostatic charging heads 422, 424 may take a variety of forms including, for example and without limitation, a fluid knife, an ionizing bar, an ionizing tube, an ionizing air gun, and ionizing nozzle, an ionizing blower, and/or an x-ray generator.

While specific mention has been made herein to the first surface and the second surface of the flexible glass, it should be understood that the relative positioning of the first surface and the second surface of the flexible glass may be modified without departing from the scope of the present disclosure. In one example, the second laminate material may be applied to the opposite side of the flexible glass, such that the flexible glass may be wound in a direction along the processed glass tape-up spool in a direction opposite the direction of the glass laminate pay-out spool. In another example, the flexible glass may undergo a plurality of turning operations in the glass processing apparatus that results in the inversion of the flexible glass, such that application of the second laminate material to the flexible glass is inverted relative to the embodiment depicted in FIG. 3.

Referring again to FIG. 1, in some embodiments, the second laminate material 122 may be the first laminate material 120 that is spooled on the laminate material take-up spool 150 after being separated from the flexible glass 110. In this embodiment, the laminate material take-up spool 150 (and the first laminate material 120) is subsequently used as the second laminate material spool 410 (and the second laminate material 122) in processing of the flexible glass 110. Reuse of the first laminate material 120 reduces laminate material usage and associated manufacturing costs. In other embodiments, the second laminate material 122 may also be a previously unused material. In these embodiments, the second laminate material includes identical material properties to the first laminate material. In other embodiments, the second laminate material 122 includes different material properties than the first laminate material. In yet further embodiments, the second laminate material may be provided in a stack of discrete sheets (not depicted) for inter-leaving with discrete sheets of flexible glass.

Referring now to FIG. 4, a cross-sectional view of one embodiment of the processed glass take-up spool 430 having a plurality of layers of processed glass laminate 436 wound about a core 434 is depicted. The flexible glass 110 is depicted in alternating layers with the second laminate material 122. The width 437 of the second laminate material 122 may be greater than the width 111 of the flexible glass 110. In other embodiments (not shown), the width of the second laminate material may be equal to or less than the width of the flexible glass. As discussed hereinabove, the second laminate material 122 provides protection to adjacent layers of the flexible glass 110, for example when transporting the processed glass laminate 436. The effective diameter 435 of the processed glass take-up spool 430 increases as successive layers of the processed glass laminate 436 are wound around the core 434. As such, the rate of rotation of the processed glass take-up spool 430 may be slowed with increasing effective diameter 435, such that the linear feed rate of the flexible glass 110 traversing through the manufacturing operation stations of the glass processing apparatus is constant. Further, in embodiments where the tension of the flexible glass 110 is controlled by operation of the processed glass take-up spool 430, the torque applied to the processed glass take-up spool 430 may be decreased with increasing effective diameter 435, such that a constant force is applied to the flexible glass 110.

The apparatuses and methods for paying-out a glass laminate from a spool, separating the glass laminate into flexible glass and a first laminate material, processing the flexible glass, and pinning the flexible glass to a second laminate material are disclosed herein. The apparatuses and methods are suited for use in conjunction with flexible glass having a thickness of 0.3 mm or less. The apparatuses and methods described herein may be used to separate for flexible glass formed with, for example, the fusion draw process or similar downdraw processes. It should be understood that stresses, deformation, contamination and surface irregularities of the flexible glass can be mitigated by using a laminate material to provide a physical barrier between the flexible glass and surrounding components when the flexible glass is not being processed. Use of the apparatuses and methods described herein may allow the flexible glass to be used with a laminate material, remove the laminate material while processing the flexible glass, and then pinning the flexible glass to a second laminate material. Accordingly, it should be understood that the apparatuses and methods described herein may be utilized to reduce the occurrence of breakage, buckling, and fractures in the flexible glass and thereby improve the yield of a glass laminate processing apparatus.

In a first aspect, the disclosure provides a glass laminate processing apparatus a glass laminate processing apparatus for processing flexible glass includes a plurality of processing stations arranged to direct the flexible glass along a conveyance path in a downstream direction, the glass laminate processing apparatus comprising: a glass laminate pay-out spool paying out flexible glass and a first laminate material electrostatically pinned to each other in a glass laminate; a turning roller positioned in the downstream direction of the glass laminate pay-out spool and contacting the first laminate material of the glass laminate; at least one electrostatic charging head positioned downstream of the pay-out spool, the electrostatic charging head neutralizing an electrostatic charge on at least one of the flexible glass or the first laminate material that are electrostatically pinned to each another in the glass laminate; and a laminate material take-up spool positioned downstream of the electrostatic charging head collecting the first laminate material.

In a second aspect, the disclosure provides the glass laminate processing apparatus of aspect 1, further comprising: a manufacturing operation station positioned downstream of the electrostatic device; a first electrostatic charging head positioned downstream of the manufacturing operation station, the first electrostatic charging head applying an electrostatic charge of a first polarity to the flexible glass; a second electrostatic charging head positioned downstream of the manufacturing operation station, the second electrostatic charging head applying an electrostatic charge to a second laminate material having a second polarity opposite the first polarity, wherein the first polarity of the flexible glass and the second polarity of the second laminate material electrostatically pin the flexible glass and the second laminate material to one another; and a processed glass take-up spool positioned downstream of the first and second electrostatic charging heads, the processed glass take-up spool collecting a processed glass laminate of the flexible glass and the second laminate material.

In a third aspect, the disclosure provides the glass laminate processing apparatus of aspects 1 and 2, wherein the electrostatic device comprises a first electrostatic charging head applying an electrostatic charge opposite an initial polarity of the flexible glass; and a second electrostatic charging head applying an electrostatic charge opposite the initial polarity of the first laminate material.

In a fourth aspect, the disclosure provides the glass laminate processing apparatus of aspects 1 through 3, wherein the electrostatic device comprises at least one ionizing bar removing electrostatic charge from at least one of the flexible glass or the first laminate material.

In a fifth aspect, the disclosure provides the glass laminate processing apparatus of aspects 1 through 4, wherein the second laminate material is the first laminate material that is reintroduced to the glass laminate processing apparatus.

In a sixth aspect, the disclosure provides the glass laminate processing apparatus of aspects 1 through 5, further comprising a nip roller positioned downstream of the electrostatic device and upstream of the laminate material take-up spool, the nip roller directing the first laminate material away from the flexible glass.

In a seventh aspect, the disclosure provides the glass laminate processing apparatus of aspects 1 through 6, wherein the nip roller contacts one of the first laminate material or the flexible glass.

In an eighth aspect, the disclosure provides the glass laminate processing apparatus of aspects 1 through 7, further comprising a fluid injection bar positioned downstream of the turning roller, the fluid injection bar having an ejection surface through which fluid at an elevated pressure is directed to provide a fluid cushion between the ejection surface and one of the flexible glass or the first laminate material.

In a ninth aspect, the disclosure provides the glass laminate processing apparatus of aspects 1 through 8, further comprising a tensioning roller positioned along the conveyance path, the tensioning roller comprising a tensioning mechanism and a contact surface that contacts the flexible glass, the tensioning mechanism modifying a position of the contact surface to modify a tension of the flexible glass.

In a tenth aspect, the disclosure provides the glass laminate processing apparatus of aspects 1 through 9, further comprising a glass tension monitoring device evaluating a tension of the flexible glass.

In an eleventh aspect, the disclosure provides a method of processing glass laminate comprising: directing a glass laminate through a glass laminate processing apparatus, the glass laminate comprising a flexible glass having a first polarity and a first laminate material having a second polarity opposite the first polarity, the flexible glass and the first laminate material electrostatically pinned to each other by the first and second polarities; neutralizing at least one of the first polarity or the second polarity with an electrostatic device positioned proximate to the glass laminate to unpin the flexible glass and the first laminate material; separating the flexible glass from the first laminate material; collecting the first laminate material; and processing the flexible glass in a manufacturing operation station positioned along a conveyance path of the flexible glass through the glass laminate processing apparatus.

In a twelfth aspect, the disclosure provides the method of processing glass laminate of aspect 11, further comprising collecting the flexible glass onto a processed glass take-up spool.

In a thirteenth aspect, the disclosure provides the method of processing glass laminate of aspects 11 and 12, further comprising electrostatically pin the flexible glass to the second laminate material in a processed glass laminate by: bringing the flexible glass and the second laminate material into contact with each other; applying an electrostatic charge having a first collection polarity to the flexible glass with a first electrostatic charging head; and applying an electrostatic charge having a second collection polarity opposite the first collection polarity to the second laminate material with a second electrostatic charging head.

In a fourteenth aspect, the disclosure provides the method of processing glass laminate of aspects 11 through 13, wherein the second laminate material is the first laminate material separated from the flexible glass and reintroduced to the glass laminate processing apparatus at a position proximate to the first and second electrostatic charging heads.

In a fifteenth aspect, the disclosure provides the method of processing glass laminate of aspects 11 through 14, further comprising collecting the processed glass laminate onto a processed glass take-up spool.

In a sixteenth aspect, the disclosure provides the method of processing glass laminate of aspects 11 through 15, wherein the electrostatic device comprises a first electrostatic charging head positioned proximate to the glass laminate to neutralize electrostatic charge on the flexible glass and a second electrostatic charging head positioned proximate to the glass laminate to neutralize electrostatic charge on the first laminate material.

In a seventeenth aspect, the disclosure provides the method of processing glass laminate of aspects 11 through 16, wherein the electrostatic device comprises at least one ionizing bar neutralizing electrostatic of at least one of the flexible glass or the first laminate material.

In an eighteenth aspect, the disclosure provides the method of processing glass laminate of aspects 11 through 17, further comprising turning the glass laminate along the conveyance path with a turning roller positioned upstream of the electrostatic device, wherein the turning roller contacts the first laminate material of the glass laminate.

In a nineteenth aspect, the disclosure provides the method of processing glass laminate of aspects 11 through 18, further comprising maintaining tension of the flexible glass through the glass laminate processing apparatus from about 0.05 pounds per linear inch to about 0.75 pounds per linear inch.

In a twentieth aspect, the disclosure provides the method of processing glass laminate of aspects 11 through 19, further comprising contacting the first laminate material with a nip roller positioned downstream of the electrostatic device to pull the first laminate material away from the flexible glass.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A glass laminate processing apparatus for processing flexible glass includes a plurality of processing stations arranged to direct the flexible glass along a conveyance path in a downstream direction, the glass laminate processing apparatus comprising:
a glass laminate pay-out spool paying out flexible glass and a first laminate material electrostatically pinned to each other in a glass laminate;
an electrostatic device comprising at least one electrostatic charging head positioned downstream of the glass laminate pay-out spool, the electrostatic charging head neutralizing an electrostatic charge on at least one of the flexible glass or the first laminate material that are electrostatically pinned to each another in the glass laminate; and
a laminate material take-up spool positioned downstream of the electrostatic charging head collecting the first laminate material.

2. The glass laminate processing apparatus of claim 1, further comprising a tensioning roller positioned along the conveyance path in the downstream direction from the glass laminate pay-out spool, the tensioning roller comprising a tensioning mechanism and a contact surface that contacts at least one of the flexible glass or the first laminate material.

3. The glass laminate processing apparatus of claim 2, wherein the tensioning mechanism modifies a position of the contact surface to modify a tension of the flexible glass.

4. The glass laminate processing apparatus of claim 1, further comprising:
a manufacturing operation station positioned downstream of the electrostatic device;
a first electrostatic charging head positioned downstream of the manufacturing operation station, the first electrostatic charging head applying an electrostatic charge of a first polarity to the flexible glass;
a second electrostatic charging head positioned downstream of the manufacturing operation station, the second electrostatic charging head applying an electrostatic charge to a second laminate material having a second polarity opposite the first polarity, wherein the first polarity of the flexible glass and the second polarity of the second laminate material electrostatically pin the flexible glass and the second laminate material to one another; and
a processed glass take-up spool positioned downstream of the first and second electrostatic charging heads, the processed glass take-up spool collecting a processed glass laminate of the flexible glass and the second laminate material.

5. The glass laminate processing apparatus of claim 4, wherein the second laminate material is the first laminate material that is reintroduced to the glass laminate processing apparatus.

6. The glass laminate processing apparatus of claim 1, wherein the at least one electrostatic charging head comprises a first electrostatic charging head applying an electrostatic charge opposite an initial polarity of the flexible glass; and
a second electrostatic charging head applying an electrostatic charge opposite the initial polarity of the first laminate material.

7. The glass laminate processing apparatus of claim 1, wherein the electrostatic charging head comprises at least one ionizing bar removing electrostatic charge from at least one of the flexible glass or the first laminate material.

8. The glass laminate processing apparatus of claim 1, further comprising a nip roller positioned downstream of the electrostatic device and upstream of the laminate material take-up spool, the nip roller directing the first laminate material away from the flexible glass.

9. The glass laminate processing apparatus of claim 1, further comprising a fluid injection bar positioned downstream of the electrostatic device, the fluid injection bar having an ejection surface through which fluid at an elevated pressure is directed to provide a fluid cushion between the ejection surface and one of the flexible glass or the first laminate material.

10. The glass laminate processing apparatus of claim 1, further comprising a glass tension monitoring device evaluating a tension of the flexible glass.

11. A method of processing glass laminate comprising:
directing a glass laminate through a glass laminate processing apparatus, the glass laminate comprising a flexible glass having a first polarity and a first laminate material having a second polarity opposite the first polarity, the flexible glass and the first laminate material electrostatically pinned to each other by the first and second polarities;
neutralizing at least one of the first polarity or the second polarity with an electrostatic device positioned proximate to the glass laminate to unpin the flexible glass and the first laminate material;
separating the flexible glass from the first laminate material;
collecting the first laminate material; and
processing the flexible glass in a manufacturing operation station positioned along a conveyance path of the flexible glass through the glass laminate processing apparatus.

12. The method of claim 11, further comprising collecting the flexible glass onto a processed glass take-up spool.

13. The method of claim 11, further comprising electrostatically pinning the flexible glass to a second laminate material in a processed glass laminate by:
bringing the flexible glass and the second laminate material into contact with each other
applying an electrostatic charge having a first collection polarity to the flexible glass with a first electrostatic charging head; and
applying an electrostatic charge having a second collection polarity opposite the first collection polarity to the second laminate material with a second electrostatic charging head.

14. The method of claim 13, wherein the second laminate material is the first laminate material separated from the flexible glass and reintroduced to the glass laminate processing apparatus at a position proximate to the first and second electrostatic charging heads.

15. The method of claim 13, further comprising collecting the processed glass laminate onto a processed glass take-up spool.

16. The method of claim 11, wherein the electrostatic device comprises a first electrostatic charging head positioned proximate to the glass laminate to neutralize electrostatic charge on the flexible glass and a second electrostatic charging head positioned proximate to the glass laminate to neutralize electrostatic charge on the first laminate material.

17. The method of claim 11, wherein the electrostatic device comprises at least one ionizing bar neutralizing electrostatic of at least one of the flexible glass or the first laminate material.

18. The method of claim 11, further comprising turning the glass laminate along the conveyance path with a turning roller positioned upstream of the electrostatic device, wherein the turning roller contacts the first laminate material of the glass laminate.

19. The method of claim 11, further comprising maintaining tension of the flexible glass through the glass laminate processing apparatus from about 0.05 pounds per linear inch to about 0.75 pounds per linear inch.

20. The method of claim 11, further comprising contacting the first laminate material with a nip roller positioned downstream of the electrostatic device to pull the first laminate material away from the flexible glass.
